(19) United States
(12) Patent Application Publication
(10) Pub. No.: US 2006/0250209 A1
(43) Pub. Date: Nov. 9, 2006

(54) Temperature sensitive protection device for circuits

(76) Inventor: Tsung-Mou Yu, Taipei (TW)

Correspondence Address: LIN & ASSOCIATES INTELLECTUAL PROPERTY, P.O. BOX 2339, SARATOGA, CA, 95070-0339, US

(21) Appl. No.: 11/121,257

(22) Filed: May 3, 2005

(51) Int. Cl. H01H 37/12; H01H 37/54

(52) U.S. Cl. 337/36

(57) ABSTRACT

A protection device includes a bimetallic plate electrically connected between the first and second terminals, and the bimetallic plate is bent upward to separate two contact points when overload to cut off the circuit. A contact plate has a first end in contact with the second terminal and a second end of the contact plate is forced to be connected to a second end of the carrier by a breakable piece that is made by low melting point metal. When overload and the bimetallic plate does not bend as expected, the breakable piece collapses or melts at a pre-set temperature to separate the second end of the contact plate and the carrier.

### FIELD OF THE INVENTION

The present invention relates to a temperature sensitive protection device for circuits and includes a breakable piece, which melts or breaks when a pre-set temperature is reached so as to cut off the circuit.

### BACKGROUND OF THE INVENTION

A conventional protection device for electric appliance uses fuses that are broken when overheat due to overload. After the fuses are broken, the circuit is cut off so that the electric appliance is avoided from being burned. In the modern design of the electric appliance, several circuits are involved and each circuit has a switch or protection device so as to achieve multiple layers of protection.

As shown in FIG. 1, a latest protection device includes a bimetallic plate 201 which has a first end fixed to a first terminal 202 and a second end is a free end which has a first contact point 203, connected to an underside thereof. A second contact point 205 is fixed on a second terminal 204 and when the first and second contact points 203, 205 are in contact with each other, the circuit is in “ON” status. When overload, as shown in FIG. 2, the high temperature makes the bi-metallic plate 201 bend upward so that the first and second contact points 203, 205 are separated and the circuit is in “OFF” status. By this way, the appliance is protected from being burned. However, it is a difficult task to ensure and manufacture bimetallic plates of the same physical characters. Some of the bi-metallic plates do not bend at desired temperature and the range of the temperature is too wide to precisely set the bimetallic plates have the same characters. Furthermore, some bimetallic plates are not so sensitive to the temperature and do not react as desired. Besides, when the bimetallic plate bends less than as desired, the small gap between the two contact points might generate sparks to burn the whole appliance.

The present invention intends to provide a protection device that includes a bimetallic plate and a breakable piece that connects a contact plate to a carrier that is in contact with the bimetallic plate. The breakable piece breaks due to high temperature when overload to cut off the circuit.

### SUMMARY OF THE INVENTION

The present invention relates to a protection device that comprises a bimetallic plated having a first end fixed to a first terminal and a second of the bimetallic plate has a first contact point. A carrier has a second contact point connected on a first end thereof and the second contact point is located beneath the first contact point. A contact plate has a first end in contact with a second terminal and a second end of the contact plate is forced to connect to a second end of the carrier by a breakable piece that is made by low melting point metal. The breakable piece collapses or melts to separate the second end of the contact plate and the carrier when overload.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 shows a conventional protection device in “ON” status;

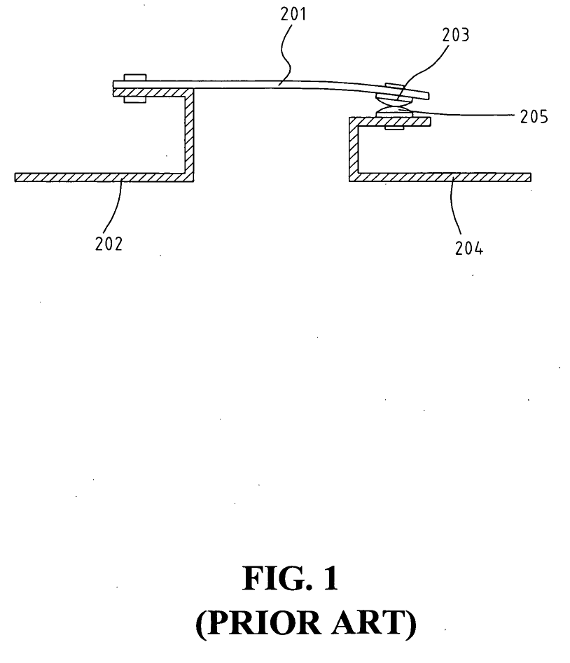

FIG. 2 shows the conventional protection device in “OFF” status;

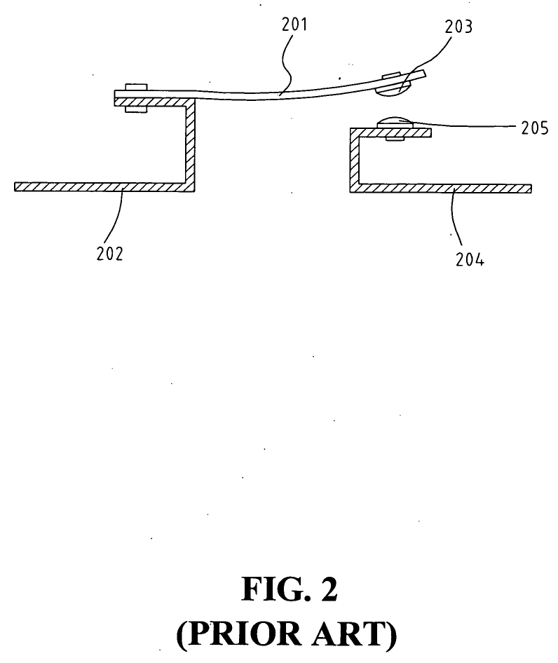

FIG. 3 shows a protection device in accordance with the present invention in “ON” status;

FIG. 4 shows the protection device of the present invention in “OFF” status where the bimetallic plate is bent upward;

FIG. 5 shows an exploded view of the protection device using a breakable piece, and

FIG. 6 shows that the breakable piece collapses and the contact plate is separated from the carrier.

### DETAILED DESCRIPTION OF THE PREFERRED EMBODIMENT

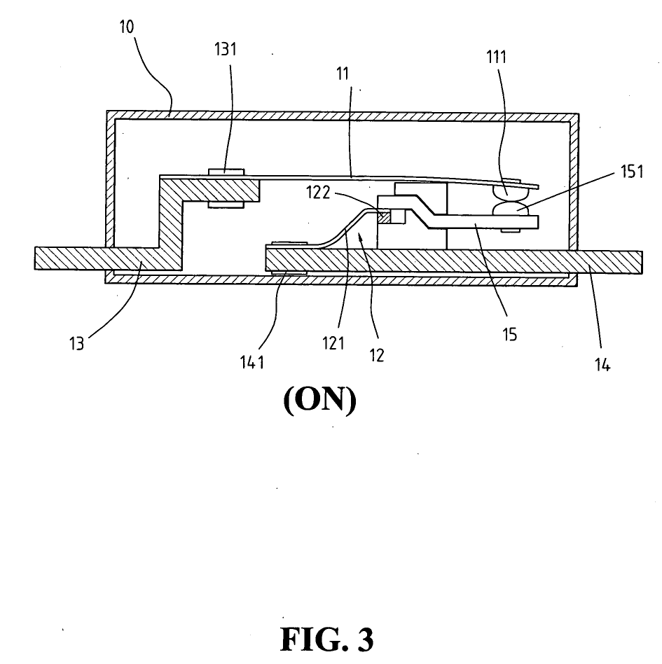

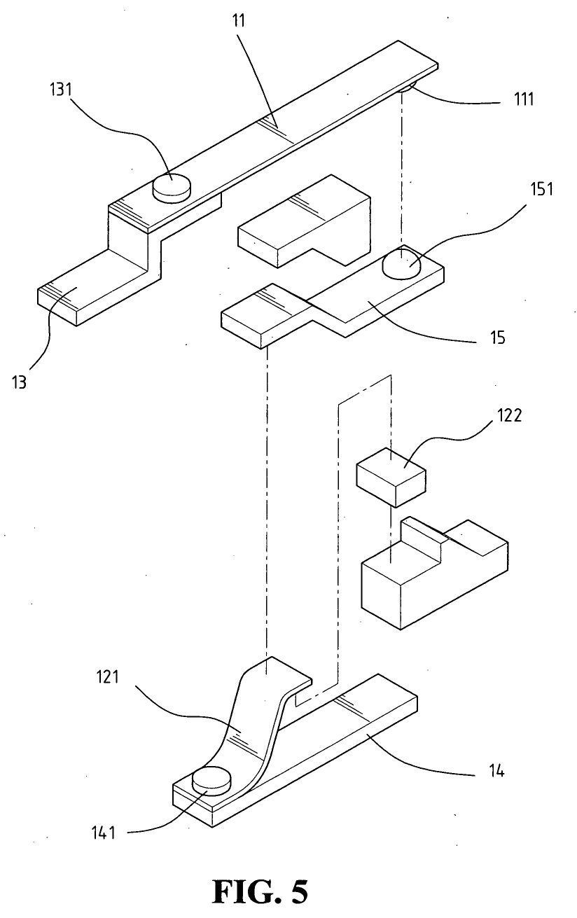

Referring to FIGS. 3 and 5, the protection device of the present invention comprises a first protection device and a second protection device 12. The first protection device includes a curve bimetallic plate 11 which has a first end fixed to a first terminal 13 by a rivet 131. A second end of the bimetallic plate 11 is a free end which has a first contact point 111 connected to an underside thereof. A carrier 15 is clamped between two positioning members and has a second contact point 151 connected on a first end thereof. The second contact point 151 located beneath the first contact point 111.

The second protection device 12 includes a contact plate 121 that has a first end connected to a second terminal 14 by another rivet 141 and a second end of the contact plate 121 is forced to connect to a second end of the carrier 15 by a breakable piece 122 which is made by low melting point metal and is a solid piece. The first and second terminals 13, 14 extend out from a box 10. The second end of the contact plate 121 tends to be separated from the carrier 15 when the breakable piece 122 is not yet to connect the contact plate 121 to the carrier 15. The breakable piece 122 is not used as a part of the circuit; the circuit is completed via the first terminal 13, the bimetallic plate 11, the first and second contact points 111, 151, the carrier 15, the contact plate 121, and the second terminal 14.

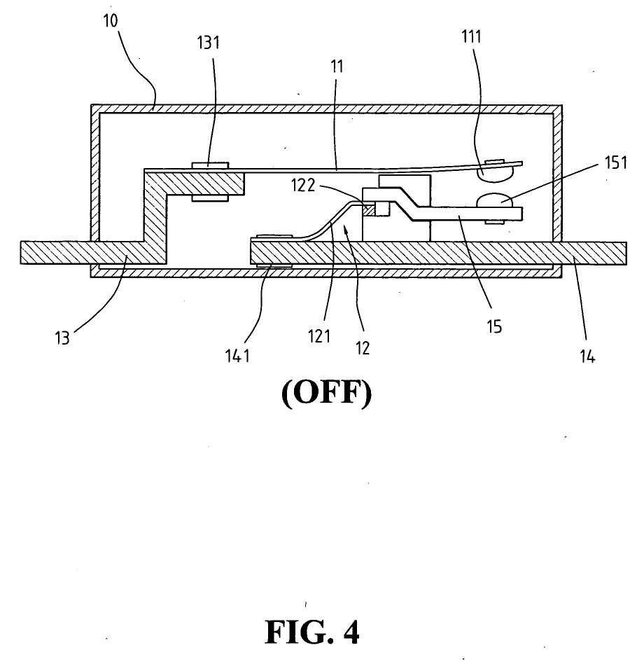

As shown in FIG. 4, when overload, the bimetallic plate 11 is bent upward so that the first and second contact points 111, 151 are separated so as to cut off the circuit. This is the first stage of protection for the circuit.

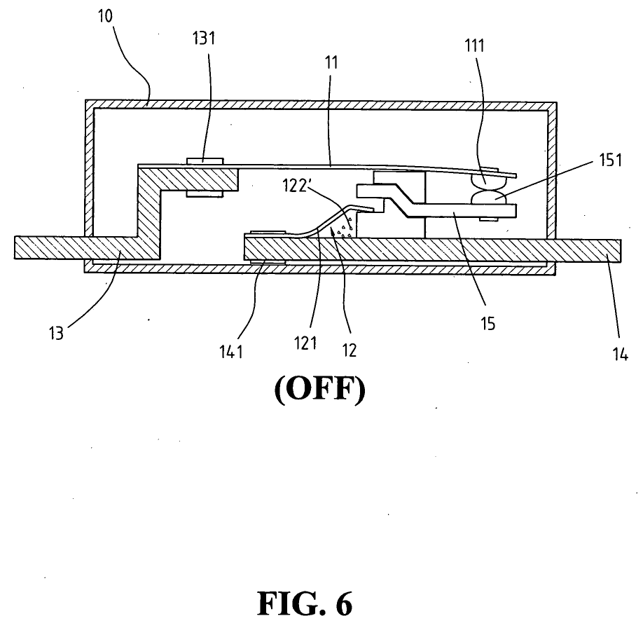

As shown in FIG. 6, if the bimetallic plate 11 is not bent as expected when overload, the breakable piece 122 collapses into small debris or melts due to a pre-set temperature is reached and, according to the nature of the contact plate 121, the second end of the contact plate 121 is separated from the carrier 15 to cut off the circuit when the breakable piece 122 collapses.

Therefore, there are two independent protection devices to ensure that the circuit is cut off when overload.

While we have shown and described the embodiment in accordance with the present invention, it should be clear to those skilled in the art that further embodiments may be made without departing from the scope of the present invention.

What is claimed is:

1. A protection device comprising:
a bimetallic plate having a first end fixed to a first terminal and a second of the bimetallic plate being a free end which has a first contact point connected to an underside thereof;
a carrier having a second contact point connected on a first end thereof and the second contact point located beneath the first contact point, and
a contact plate having a first end being in contact with a second terminal and a second end of the contact plate being forced to be connected to a second end of the carrier by a breakable piece, the breakable piece melts or collapses to separate the second end of the contact plate and the carrier when overload.

2. The device as claimed in claim 1, wherein the bimetallic plate is a curve plate.

3. The device as claimed in claim 1, wherein the breakable piece is a solid piece.

4. The device as claimed in claim 1, wherein the breakable piece is made by low melting point metal.
